(19) United States
(12) Patent Application Publication
(10) Pub. No.: US 2005/0271236 A1
(43) Pub. Date: Dec. 8, 2005

(54) Coaxial speaker device and manufacturing method thereof

(76) Inventors: Hiroyuki Kobayashi, Yamagata (JP); Kenichi Kasahara, Yamagata (JP); Shinichi Hayasaka, Yamagata (JP); Toshihiro Hikichi, Yamagata (JP)

Correspondence Address: YOUNG & THOMPSON, 745 SOUTH 23RD STREET, 2ND FLOOR, ARLINGTON, VA, 22202, US

(21) Appl. No.: 11/086,206

(22) Filed: Mar. 23, 2005

(30) Foreign Application Priority Data
Mar. 25, 2004 (JP) 2004-89322

(51) Int. Cl. H04R 25/00

(52) U.S. Cl. 381/396; 381/398

(57) ABSTRACT

A speaker device includes speaker units for high-frequency band reproduction and for low-frequency band reproduction and a supporting member. fixed to an opening of a center pole of the speaker unit for low-frequency band reproduction, serves as a lower frame of the speaker unit for low-frequency band reproduction, and has a frame portion onto which an upper end surface and engaging claws are formed. The speaker unit for high-frequency band reproduction has a frame portion, a magnetic circuit system, an upper frame, a diaphragm having an edge portion and a cover. On the upper frame, an engaging recess portion is formed, and at the outer peripheral edge portion of the diaphragm, a recess portion corresponding to the engaging recess portion is formed. The upper frame is fixed onto the upper surface of the magnetic circuit system, and the diaphragm is fixed onto the upper frame, respectively.

### TECHNICAL FIELD

The present invention relates to a method of fixing, to a supporting member, a speaker unit for high-frequency band reproduction in a coaxial speaker.

### BACKGROUND ART

As a speaker capable of realizing flat sound reproduction from low-frequency band to high-frequency band, there is known a coaxial speaker in which a speaker unit for low-frequency band reproduction (a so-called woofer) and a speaker unit for high-frequency band reproduction (a so-called tweeter) are coaxially disposed via a supporting member, for example.

As such the kind of speakers, there is known a thin light multiway speaker having a structure of attaching a mount coaxially disposed on an inner bottom surface of a frame and a bottom magnetic plate by an adhesive agent, for example (see Japanese Utility Model Publication No. 3002891).

However, in the above speaker, since the tweeter and an upper end surface of the supporting member are fixed only by the adhesive agent, the tweeter and the supporting member are problematically leaned by weight of the tweeter itself until the adhesive agent is solidified. Therefore, it is difficult to stably fix the speaker unit for high-frequency band reproduction to the supporting member.

### DISCLOSURE OF THE INVENTION

As a problem that the invention is to solve, the above problem is taken as an example. An object of the invention is to provide a speaker device capable of stably fixing a speaker unit for high-frequency band reproduction to a supporting member.

According to one aspect of the present invention, there is provided a speaker unit including: a magnetic circuit unit; a supporting member which has a frame portion supporting the magnetic circuit unit; and a cover mounted to the frame portion and covering the magnetic circuit unit, wherein the magnetic circuit unit is fixed to a supporting surface of the frame portion by an adhesive agent, and is sandwiched by the cover and the supporting surface.

The above speaker unit is configured as the speaker unit for high-frequency band reproduction for example, and the magnetic circuit unit including a magnetic circuit and a diaphragm is supported by the frame portion of the supporting member. The magnetic circuit unit is fixed onto the supporting surface of the frame portion by the adhesive agent, and the cover is mounted on the frame portion to cover the magnetic circuit unit. Thereby, the magnetic circuit unit is sandwiched by the supporting surface of the frame portion and the cover. Therefore, when the magnetic circuit unit is attached to the frame portion at the time of manufacturing the speaker unit, the magnetic circuit unit is never leaned by its weight, and the speaker unit can be stably mounted to the supporting member.

In a form of the above speaker unit, the frame portion may have an engaging claw formed at a peripheral end portion, the cover may have an opening formed in a vicinity of the peripheral end portion of the cover opposite to an outer circumferential wall of the peripheral end portion of the frame portion, and the cover may be mounted to the frame portion by engaging the engaging claw with the opening. In this form, the cover and the outer circumference of the frame portion are stably fixed by engaging the engaging claw with the opening.

In another form, the above speaker unit may further include: an upper frame which is fixed onto the magnetic circuit unit; and a diaphragm which is fixed onto the upper frame and has an edge portion, wherein a recess portion is formed at an outer peripheral edge portion of the edge portion, wherein a projecting part projecting to a side of the recess portion is formed at a position on the cover, opposite to the recess portion, and wherein the projecting body pushes and presses the magnetic circuit unit via the recess portion and the upper frame. Thereby, the magnetic circuit unit is appropriately pushed and pressed to the supporting surface of the frame portion.

In still another form of the above speaker unit, a projecting portion may be formed at the outer peripheral edge portion of the edge portion, an engaging projecting portion may be formed at a position corresponding to the projecting portion on an upper surface of the upper frame, and the projecting portion and the engaging projecting portion may be in contact with each other. In this form, the diaphragm and the upper frame can be positioned with high accuracy.

In still another form of the above speaker unit, the magnetic circuit unit may include a plate arranged opposite to a lower surface of the upper frame, the cover may have an engaging projecting part projecting to a side of an outer peripheral edge portion of the plate, a claw portion may be formed at a peripheral end portion of the engaging projecting part, the claw portion may engage with at least one portion of a bottom portion of the outer peripheral edge portion of the plate, and the plate may be sandwiched by the claw portion and the projecting part. In this form, by the claw portion formed on the cover, the cover and the magnetic circuit unit can be stably fixed.

According to another aspect of the present invention, there is provided a coaxial speaker device, including: a speaker unit for high-frequency band reproduction, including a magnetic circuit unit, a supporting member having a frame portion supporting the magnetic circuit unit, and a cover which is mounted to the frame portion and covers the magnetic circuit unit, wherein the magnetic circuit unit is fixed to a supporting surface of the frame portion by an adhesive agent and is sandwiched by the cover and the supporting surface; and a speaker unit for low-frequency band reproduction, wherein the speaker unit for low-frequency band reproduction and the speaker unit for high-frequency band reproduction are coaxially disposed via the supporting member, and wherein an end portion opposite to the frame portion of the supporting member is mounted to the speaker unit for low-frequency band reproduction.

In the above coaxial speaker device, the speaker unit for low-frequency band reproduction and the speaker device for high-frequency band reproduction are coaxially connected via the supporting member. Namely, the one end of the supporting member is mounted to the speaker unit for low-frequency band reproduction, and the other end thereof is mounted to the speaker unit for high-frequency band reproduction.

In a form of the above coaxial speaker device, the supporting member may be formed by integrating a connecting portion connecting the speaker unit for low-frequency band reproduction and the speaker unit for high-frequency band reproduction and the frame portion functioning as a lower frame of the speaker unit for high-frequency band reproduction. In this form, since the one portion of the connecting member functions as the lower frame of the speaker unit for high-frequency band reproduction, the speaker unit for high-frequency band reproduction can be stably mounted to the supporting member.

According to still another aspect of the present invention, there is provided a method of manufacturing a coaxial speaker device, including: a process which inserts a lower end portion of a supporting member to an opening formed at a center portion of a speaker unit for low-frequency band reproduction, thereby to fix the supporting member to the speaker unit for low-frequency band reproduction; a process which fixes a magnetic circuit unit of a speaker unit for high-frequency band reproduction to an upper end surface of a frame portion, which is one portion of the supporting member, by an adhesive agent; a process which mounts a cover, having a projecting portion pushing and pressing the magnetic circuit unit, to the frame portion to cover the magnetic circuit unit; and a process which inserts a fastening member from a direction opposite to a sound output side to the opening of the speaker unit for low-frequency band reproduction and a through hole passing through a central axis of the supporting member, thereby to fix the speaker unit for low-frequency band reproduction, the supporting member and the speaker unit for high-frequency band reproduction.

In accordance with the above method of manufacturing the coaxial speaker device, first, the supporting member is mounted to the speaker unit for low-frequency band reproduction. Next, the magnetic circuit unit of the speaker unit for high-frequency band reproduction is attached to the frame portion of the supporting member, and the cover is further mounted to the frame portion. The fastening member is inserted from the direction opposite to the sound output side to the opening of the speaker unit for low-frequency band reproduction and the through hole passing through the central axis of the supporting member, and the speaker unit for low-frequency band reproduction, the supporting member and the speaker unit for high-frequency band reproduction are integrated. Since the frame portion of the supporting member functions as the lower frame of the speaker unit for high-frequency band reproduction, the speaker unit for high-frequency band reproduction can be stably mounted to the supporting portion.

### BRIEF DESCRIPTION OF THE DRAWINGS

FIG. 1A shows a sectional view of a construction of a speaker device according to an embodiment of the present invention, and FIG. 1B shows a perspective view thereof;

FIGS. 2A to 2D show sectional views in which a system supporting a speaker unit for high-frequency band reproduction according to this embodiment on an upper end surface of a supporting member is enlarged;

FIG. 3 shows a flow chart of a manufacturing method of the speaker device according to the embodiment of the present invention;

FIG. 4 shows a flow chart of a manufacturing method of a speaker unit for high-frequency band reproduction;

FIGS. 5A to 5D show sectional views of each manufacturing process of the speaker unit for high-frequency band reproduction;

FIGS. 6A and 6B show sectional views of each manufacturing process of the speaker unit for high-frequency band reproduction;

FIGS. 7A and 7B show sectional views of each manufacturing process of the speaker unit for high-frequency band reproduction; and

FIGS. 8A and 8B show sectional views of each manufacturing process of the speaker device.

### BEST MODE FOR CARRYING OUT THE INVENTION

Hereinafter, preferred embodiment of the invention will be described by referring to the drawings. The embodiment stably fixes, to the supporting member, the speaker unit for high-frequency band reproduction in the coaxial speaker.

[Configuration of Speaker Device]

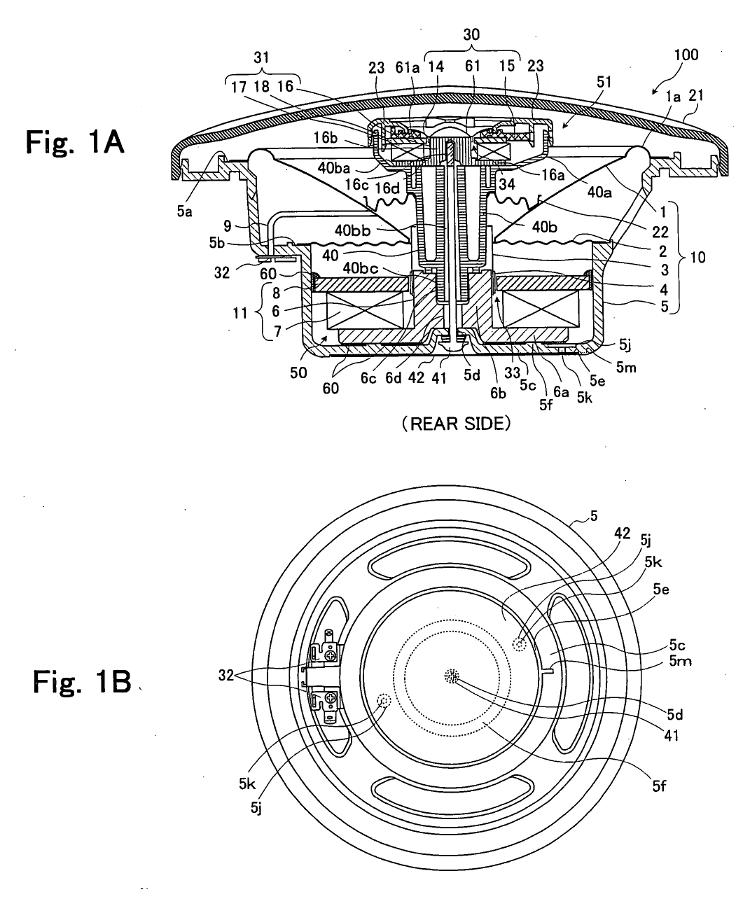

First, in FIGS. 1A and 1B, an outline configuration of a speaker device 100 according to the embodiment of the present invention is schematically shown. FIG. 1A is a sectional view when the speaker device 100 is cut along a plane containing a central axis thereof. FIG. 1B is a rear view of the speaker device 100. The speaker device 100 in the embodiment can be used preferably as a marine speaker or a vehicle speaker. As below, referring to FIGS. 1A and 1B, the configuration etc. of the speaker device 100 of the embodiment will be described.

The speaker device 100 includes a speaker unit 50 for low-frequency band reproduction, a speaker unit 51 for high-frequency band reproduction, and other various kinds of members. The speaker device 100 is a so-called coaxial type two-way speaker, and is configured by coaxially disposing the speaker unit 51 for high-frequency band reproduction at the sound output side and the speaker unit 50 for low-frequency band reproduction at the rear side. Accordingly, the speaker device 100 can realize flat sound reproduction from the low-frequency band to the high-frequency band. Incidentally, the speaker unit 50 for low-frequency band reproduction may be a speaker unit capable of low and middle frequency band reproduction. Further, the speaker unit 51 for high-frequency band reproduction may be a speaker unit capable of high and middle frequency band reproduction.

First, a configuration of the speaker unit 50 for low-frequency band reproduction will be described. The speaker unit 50 for low-frequency band reproduction mainly includes a vibration system 10 having a diaphragm 1, a damper 2, a waterproof damper 22, a voice coil bobbin 3, a voice coil 4 and a resin frame 5, a magnetic circuit system 11 having a pole piece 6, an annular magnet 7 and an annular plate 8, and a resin grille 21.

First, the respective constitutive elements of the vibration system 10 will be described.

The diaphragm 1 is a so-called conical diaphragm, and a separate edge portion 1a is bonded thereto or the diaphragm 1 is formed integrally with the edge portion 1a. Various kinds of materials such as paper, polymer or metal can be applied to the diaphragm 1 according to various kinds of application. The outer peripheral edge of the diaphragm 1, namely, the lower end part of the edge portion 1a is fixed onto a first flange portion 5a located at the upper part of the resin frame 5. On the other hand, the inner peripheral edge of the diaphragm 1 is fixed onto the vicinity of the upper end of the outer circumferential wall of the voice coil bobbin 3.

The damper 2 is made of a material of cloth impregnated with a thermosetting resin such as phenol resin or the like, and plural corrugations are concentrically formed. The damper 2 movably supports the voice coil bobbin 3. The inner peripheral edge of the damper 2 is fixed to the outer circumferential wall of the voice coil bobbin 3. On the other hand, the outer peripheral edge of the damper 2 is fixed onto a second flange portion 5b formed in the vicinity of the central part of the resin frame 5.

The waterproof damper 22 fulfills a function of preventing water droplets etc. from entering from the sound output side into the magnetic circuit system 11 etc. For the purpose, as a material for the waterproof damper 22, for example, a material such as thermoplastic elastomer is appropriate. The outer peripheral edge of the waterproof damper 22 is mounted in a predetermined position of the diaphragm 1, and the inner peripheral edge of the waterproof damper 22 is mounted to the outer circumferential wall of a connecting portion 40b of a supporting member 40, which will be described later.

The voice coil bobbin 3 has a substantially cylindrical shape. The voice coil 4 is wound around the outer circumferential wall of the lower end part of the voice coil bobbin 3. Further, the outer circumferential wall of the lower end part of the voice coil bobbin 3 faces the inner circumferential wall of the annular plate 8 with a certain space therebetween. Furthermore, the inner circumferential wall of the lower end part of the voice coil bobbin 3 faces the outer circumferential wall of the upper end part of the pole piece 6 with a certain space therebetween. Thus, a gap (magnetic gap 33) is formed between the outer circumferential wall of the upper end part of the pole piece 6 and the inner circumferential wall of the plate 8.

The voice coil 4 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires 9 in the predetermined position of the diaphragm 1 and the other ends of the respective tinsel wires 9 are electrically connected to a connection terminal 32. To the voice coil 4, electric signals for one channel are input from an amplifier (not shown) side via the connection terminal 32 and the tinsel wires 9.

The resin frame 5 is a frame made of a resin material. Onto the resin frame 5, various components of the speaker device 100 are fixed, and the resin frame 5 serves to support the speaker device 100. The resin frame 5 has a shape of a pan or pot opening upwardly, and has the first flange portion 5a that supports the edge portion 1a of the diaphragm 1, the second flange portion 5b that supports the outer peripheral edge of the damper 2, and a mounting portion 5c on which the magnetic circuit system 11 is placed.

The first flange portion 5a is formed in a position of the upper part of the resin frame 5, and the second flange portion 5b is formed in a position of the central part of the resin frame 5. The mounting portion 5c is formed in a position at the lower part side of the resin frame 5, namely, at the rear side thereof. A recess having a truncated cone shape is formed in the vicinity of the central axis of the mounting portion 5c from the lower surface side to the upper surface side thereof. The mounting portion 5c has an opening 5d on the central axis thereof, a step portion 5j and a hole portion 5k in the vicinity of the peripheral edge thereof, and a recess (concave) portion 5e and a slit 5m at the rear side thereof. The step portion 5j, the hole portion 5k, the recess portion 5e and the slit 5m serve to prevent production of air bubbles of an adhesive agent 60 due to volume change of space between the magnetic circuit system 11 and the resin frame 5 at the time of assembly of the speaker unit 50 for low-frequency band reproduction. A fastening member 41, which will be described later, penetrates the opening 5d, and a nameplate 42, which will be described later, is attached to the recess portion 5e. The name plate 42 is used for application of improvement of the appearance of the rear side of the speaker 100 or recognition of product information etc. for users.

Next, the respective constitutive elements of the magnetic circuit system 11 will be described.

The magnetic circuit system 11 is formed as an external magnet type magnetic circuit. This magnetic circuit has the pole piece 6, the annular magnet 7 and the annular plate 8.

The pole piece 6 has an inverted T section. The pole piece 6 is fixed onto the mounting portion 5c of the resin frame 5 via the adhesive agent 60. The pole piece 6 has a flange-like yoke 6a, a center pole 6b having a cylindrical shape, and openings 6c and 6d provided within the center pole 6b.

The yoke 6a is located on the mounting portion 5c of the resin frame 5. A recess having a truncated cone shape is formed in the vicinity of the central axis of the lower surface side of the center pole 6b. The openings 6c and 6d formed within the center pole 6b are respectively different in diameter, and the openings communicate with each other. The opening 6c has a diameter slightly larger than that of the opening 6d, and is formed from the vicinity of the central part of the center pole 6b to the upper part thereof. On the other hand, the opening 6d is formed at the lower end side of the opening 6c, namely, from the central part side of the center pole 6b to the lower part thereof. Further, a lower end portion 40bc of the supporting member 40, which will be described later, is inserted into the opening 6c and the supporting member 40 is fastened to the center pole 6b. Furthermore, the fastening member 41 penetrates the openings 6c and 6d. Note that the fastening member 41 penetrates the opening 6c via a thorough hole 40bb of the supporting member 40, which will be described later.

The annular magnet 7 is disposed so as to be overlapped with the upper surface of the yoke 6a, and the annular plate 8 is disposed so as to be overlapped with the upper surface of the annular magnet 7. The center pole 6b upwardly extends within the openings of the central parts of the annular magnet 7 and the annular plate 8. The outer peripheral edge of the plate 8 is fixed for reinforcement to the inner circumferential wall of the resin frame 5 via the adhesive agent 60.

In the magnetic circuit system 11, a magnetic circuit is formed by the magnet 7, the plate 8 and the pole piece 6, and the magnetic flux of the magnet 7 is concentrated in the magnetic gap 33 formed between the inner circumferential wall of the plate 8 and the outer circumferential wall of the pole piece 6.

The resin grille 21 is made of a resin material, for example, and has a function of protecting the speaker unit 50 for low-frequency band reproduction and the speaker unit 51 for high-frequency band reproduction, or the like. For this purpose, the resin grille 21 is mounted on the resin frame 5 so as to cover the speaker units. Further, striped spacings (not shown) are formed intermittently at the upper surface side of the resin grille 21 so that the speaker unit 50 for low-frequency band reproduction and the speaker unit 51 for high-frequency band reproduction can emit sound waves through the spacings to the sound output side.

Next, the speaker unit 51 for high-frequency band reproduction will be described. The speaker unit 51 for high-frequency band reproduction mainly includes a vibration system 30 having a diaphragm 61, a voice coil 14 and an upper frame 15, and a magnetic circuit system 31 having a pole piece 16, an annular magnet 17 and an annular plate 18, and a cover 23.

First, the respective constitutive elements of the vibration system 30 will be described.

The diaphragm 61 is a so-called domical diaphragm, and is formed integrally with an edge portion 61a. Various kinds of materials such as paper, polymer, or metal can be applied to the diaphragm 61 according to various kinds of application as well as the above diaphragm 1. The outer peripheral edge of the diaphragm 61, namely, the lower end part of outer peripheral edge of the edge portion 61a is fixed onto the upper surface of the resin frame 15.

The voice coil 14 has a substantially cylindrical shape. The outer circumferential wall of the voice coil 14 faces the inner circumferential wall of the annular plate 18 with a certain space therebetween. On the other hand, the inner circumferential wall of the voice coil 14 faces the outer circumferential wall of the upper end part of the pole piece 16 with a certain space therebetween. Thus, a gap (magnetic gap 34) is formed between the outer circumferential wall of the pole piece 16 and the inner circumferential wall of the plate 18.

Further, the voice coil 14 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires (not shown) and the other ends of the respective tinsel wires (not shown) are electrically connected to a connection terminal (not shown) To the voice coil 14, electric signals for one channel are input from an amplifier (not shown) side via the connection terminal and the tinsel wires.

The upper frame 15 is made of a resin material and has a substantially annular form. The upper frame 15 is disposed so as to be overlapped with the upper surface of the annular plate 18. The upper frame 15 supports the outer peripheral edge of the diaphragm 61, namely, the edge 61a.

Next, the respective constitutive elements of the magnetic circuit system 31 will be described.

The magnetic circuit system 31 is formed as an external magnet type magnetic circuit system. The magnetic circuit has the pole piece 16, the annular magnet 17 and the annular plate 18.

The pole piece 16 has an inverted T section. Flatness is ensured in the lower surface of the pole piece 16. The pole piece 16 is fixed onto an upper end surface 40ba of the supporting member 40 via the adhesive agent 60 (not shown). The pole piece 16 has a flange-like yoke 16a, a center pole 16b having a cylindrical shape, a fastening hole 16c provided within the center pole 16b, and a step portion 16d formed between the outer peripheral edge of the lower end part of the center pole 16b and the yoke 16a and having a step-like section.

The yoke 16a is located on the upper end surface 40ba of the supporting member 40. A recess having a truncated cone shape is formed in the vicinity of the central axis of the lower surface side of the center pole 16b. The fastening hole 16c has a female thread, for example, and the leading end (for example, male thread) of the fastening member 41 is inserted and screwed. The outer circumferential wall of the step portion 16d is in contact with the outer circumferential wall of the lower end part of the magnet 17.

The annular magnet 17 is disposed so as to be overlapped with the upper surface of the yoke 16a. The inner circumferential wall of the lower end part of the annular magnet 17 is disposed at the outer circumferential side of the step portion 16d of the pole piece 16 as described above, and the annular magnet 17 is precisely positioned in a predetermined position on the yoke 16a. The annular plate 18 is disposed so as to be overlapped with the upper surface of the annular magnet 17.

In the magnetic circuit system 31, a magnetic circuit is formed by the magnet 17, the plate 18 and the pole piece 16, and the magnetic flux of the magnet 17 is concentrated in the magnetic gap 34 formed between the inner circumferential wall of the plate 18 and the outer circumferential wall of the pole piece 16.

The cover 23 is made of a resin material, for example, and mounted on a frame portion 40a of the supporting member 40, which will be described later, for covering the sound output side of the speaker unit 51 for high-frequency band reproduction. The cover 23 has a function of protecting the speaker unit 51 for high-frequency band reproduction, or the like.

As other various members of the speaker device 100, the supporting member 40, the fastening member 41 and the nameplate 42 are included.

The supporting member 40 has the connecting portion 40b having a cylindrical shape and the frame portion 40a extending from the upper end surface 40ba of the connecting portion 40b upwardly so as to cover the periphery of the speaker unit 51 for high-frequency band reproduction. The cover 23 is mounted on the frame portion 40a and covers the speaker unit 51 for high-frequency band reproduction. The connecting portion 40b coaxially arranges the speaker unit 50 for low-frequency band reproduction and the speaker unit 51 for high-frequency band reproduction. The lower end part 40bc of the connecting portion 40b is inserted into the opening 6c of the pole piece 6 and fastened as described above. The speaker unit 51 for high-frequency band reproduction is fixed to the upper end surface 40ba having flatness via the adhesive agent 60 (not shown). The through hole 40bb is formed within the connecting portion 40b so that it penetrates on the central axis thereof in a vertical direction, and the fastening member 41 penetrates the through hole 40bb.

As the fastening member 41, for example, a member such as a male screw or bolt is appropriate. At the leading end of the fastening member 41, a male thread corresponding to the female thread of the fastening hole 16c is formed. The fastening member 41 is inserted into the fastening hole 16c from the rear side of the speaker device 100 through the openings 5d, 6d and 6c and the through hole 40bb. Thereby, the speaker unit 50 for low-frequency band reproduction and the speaker unit 51 for high-frequency band reproduction are coaxially fixed via the supporting member 40.

The nameplate 42 is made of a polymer material or metal material and has a disc shape. The nameplate 42 is attached to the recess portion 5e of the resin frame 5 with a sticking agent or adhesive agent as described above. The product information, company name, etc. are printed on the nameplate 42.

In the above described speaker device 100, when electric signals are input to the respective tinsel wires from the amplifier side, the electric signals are supplied to the voice coils 4 and 14 via the respective lead terminals of the voice coils 4 and 14. Thereby, driving forces are generated in the voice coils 4 and 14 within the magnetic gaps 33 and 34, respectively, and the diaphragms 1 and 61 are vibrated in the axis direction of the speaker device 100. Thus, the speaker device 100 emits sound waves to the sound output side.

[Fixing System of Speaker for High-frequency Band Reproduction]

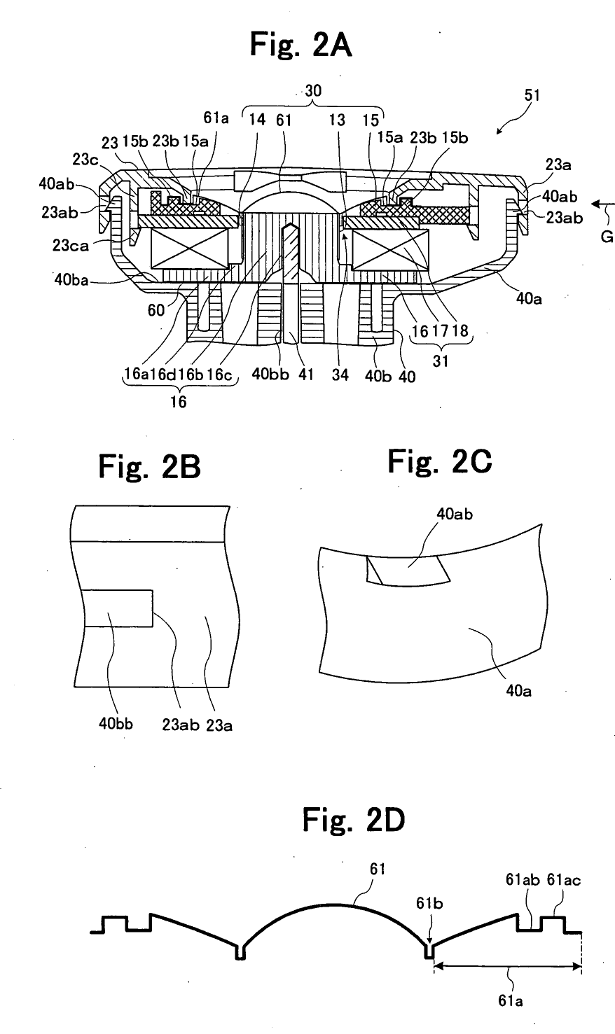

Next, the description will be given of a system of stably fixing a speaker unit 51 for high-frequency band reproduction to a supporting member 40, with reference to FIGS. 2A to 2D. FIG. 2A shows a sectional view in which an area in the vicinity of the speaker unit 51 for high-frequency band reproduction, shown in FIG. 1A is enlarged. FIG. 2B shows a sectional view of a local part of a cover 23 observed from a direction of an arrow G shown in FIG. 2A. FIG. 2C shows a perspective view of a local part around an engaging claw 40ab formed at the end portion in the circumferential direction of the frame portion 40a of the supporting member 40. FIG. 2D shows a sectional view in which only a diaphragm 61 shown in FIG. 2A is enlarged.

As understood with reference to FIG. 1A and FIG. 2A, in the speaker device 100 of this embodiment, one upper portion of the supporting member 40 connecting and supporting the speaker unit 50 for low-frequency band reproduction and the speaker unit 51 for high-frequency band reproduction also serves as the lower frame of the speaker unit 51 for high-frequency band reproduction. That is, the lower frame of the speaker unit for high-frequency band reproduction is integrated with the supporting member which connects and supports the speaker unit 50 for low-frequency band reproduction and the speaker unit 51 for high-frequency band reproduction. Concretely, the frame portion 40a formed at the upper portion of the supporting member 40 functions as the lower frame of the speaker unit 51 for high-frequency band reproduction.

The frame portion 40a has the plural engaging claws 40ab in the circumferential direction. Each engaging claw 40ab is formed at the position of the end portion in the circumferential direction of the frame portion 40a and discontinuously in the circumferential direction of the end portion in the circumferential direction. As shown in FIGS. 2A and 2C, each engaging claw 40ab has a hook-shape cross-section. It is preferable that a set of engaging claws 40ab are formed at the position opposite to each other on the same diameter of the speaker device 100, as shown in FIG. 2A. Thereby, bonding strength of the cover 23 and the frame portion 40a can be equal in the circumferential direction.

The lower surface of the pole piece 16 is fastened onto the upper end surface 40ba of the supporting member 40 via the adhesive agent 60. It is noted that both of the upper end surface 40ba and the lower surface of the pole piece 16 ensure the flatness respectively. The magnet 17 is overlapped and disposed on the yoke 16a, and the plate 18 is further overlapped and disposed on the magnet 17. In addition, the upper frame 15 made of the resin material is overlapped and disposed on the plate 18.

As shown in FIG. 2A, an engaging recess (concave) portion 15a and an engaging projecting portion 15b are formed on the upper surface of the upper frame 15 respectively. As shown in FIG. 2D, a recess (concave) portion 61ab and a projecting portion 61ac adjacent to each other are formed at the outer peripheral edge portion of the edge portion 61a of the diaphragm 61, respectively. As shown in FIG. 2D, a groove 61b to which the voice coil 14 is inserted is formed on the diaphragm 61. The outer peripheral edge portion of the edge portion 61a of the diaphragm 61 is overlapped and disposed on the upper frame 15, and the recess portion 61ab and the projecting portion 61ac are inserted to the engaging recess portion 15a and the engaging projecting portion 15b on the upper frame 15, respectively. Therefore, the engaging projecting portion 15b of the upper frame 15 prevents the diaphragm 61 from moving in the lateral direction, and the diaphragm 61 is stably fixed onto the upper frame 15.

The cover 23 has an outer peripheral portion 23a, a projecting part 23b and an engaging projecting part 23c.

The outer peripheral portion 23a is opposite to the outer circumferential wall of the peripheral end portion of the frame portion 40a. The outer peripheral portion 23a has plural openings 23ab. Each opening 23ab is formed at a position in the vicinity of the peripheral end portion of the outer peripheral portion 23a and discontinuously in the circumferential direction. Each opening 23ab is formed at a position opposite to each engaging claw 40ab of the frame portion 40a. As shown in FIG. 2B, each opening 23ab is formed into a rectangular shape and the substantially same size as each engaging claw 40ab. As shown in FIG. 2A, each engaging claw 40ab of the frame portion 40a engages with each opening 23ab.

The projecting part 23b is formed into a thin cylindrical shape, and is projecting from the lower surface of the cover 23 to the side of the recess portion 61ab of the diaphragm 61. The lower surface of the projecting part 23b having the flatness is in contact with the recess portion 61ab, and the projecting part 23b gives a constant pressure to the magnetic circuit system 31. Like this, the speaker unit 51 for high-frequency band reproduction is sandwiched by the projecting part 23b and the upper end surface 40ba of the supporting member 40.

The engaging projecting part 23c is projecting on the side of the outer peripheral edge portion of the plate 18 from the lower surface of the cover 23. The inner circumferential wall in the vicinity of the peripheral end portion of the engaging projecting part 23c is in contact with the outer peripheral edge portion of the plate 18. In addition, at the lower end portion of the engaging projecting part 23c, plural hook-shape claw portions 23ca are discontinuously formed in its circumferential direction, and each claw portion 23ca engages with at least one portion of the lower surface of the outer peripheral edge portion of the plate 18. Thus, the plate 18 is sandwiched by the projecting part 23b of the cover 23 and each claw portion 23ca.

In the speaker unit 51 for high-frequency band reproduction having the above-mentioned configuration, the cover 23 is pushed into the side of the frame portion 40a, and the recess portion 61ab of the diaphragm 61 is pushed and pressed by the lower surface of the projecting part 23b. At the same time, each engaging claw 40ab is inserted to each opening 23ab, and the magnetic circuit system 31 is fixed to the upper end surface 40ba of the frame portion 40a by the adhesive agent 60. Thereby, in the speaker unit 51 for high-frequency band reproduction, the magnetic circuit system 31 and the diaphragm 61 (hereinafter jointly referred to as “magnetic circuit unit”) are sandwiched by the projecting part 23b of the cover 23 and the upper end surface 40ba of the supporting member 40. In other words, the magnetic circuit unit accounting for the most part of the weight of the speaker unit 51 for high-frequency band reproduction is pushed and pressed on the side of the supporting member 40 by the projecting part 23d. Therefore, when the yoke 16 of the magnetic circuit unit is attached onto the upper end surface 40ba of the supporting member 40, until the adhesive agent 60 is solidified, the speaker unit 51 for high-frequency band reproduction is never leaned and dislocated by its weight, and the supporting member 40 is never leaned. Therefore, the speaker unit 51 for high-frequency band reproduction can be stably fixed onto the upper end surface 40ba of the supporting member 40.

In addition, in a state that the cover 23 is mounted to the magnetic circuit system 31, the inner peripheral wall in the vicinity of the peripheral end portion of the engaging projecting part 23c is in contact with the outer peripheral edge portion of the plate 18, and the claw portion 23ca of the engaging projecting part 23c engages with at least one portion of the lower surface of the outer peripheral edge portion of the plate 18. The adhesive agent is applied, in the entire circumference, to the area between the claw 23ca and the lower surface of the outer peripheral edge portion of the plate 18. Therefore, the plate 18 is sandwiched by the projecting part 23b and the claw portion 23ca, and it can be prevented that the position of the magnetic circuit system 31 including the plate 18 is shifted in the lateral direction.

[Manufacturing Method of Speaker Device]

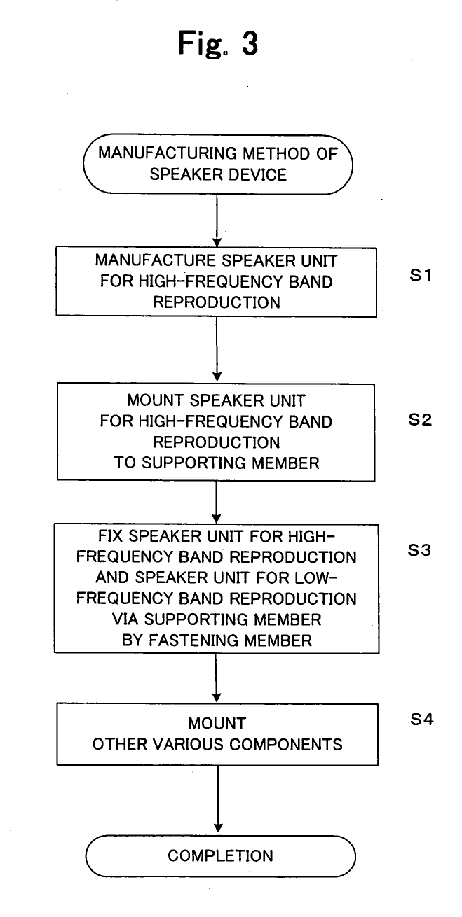

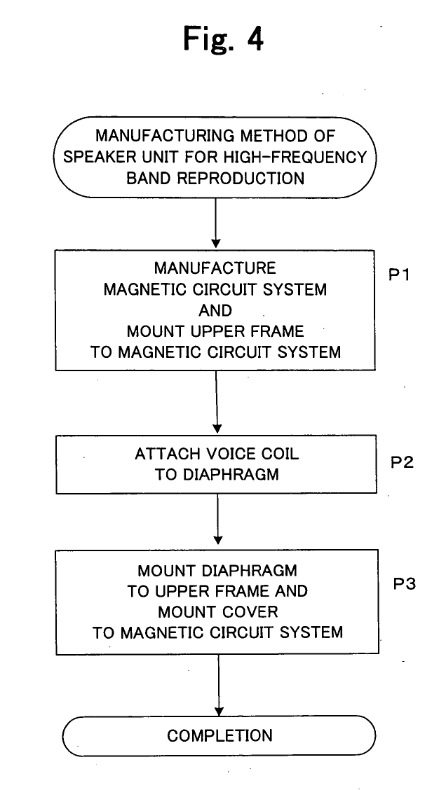

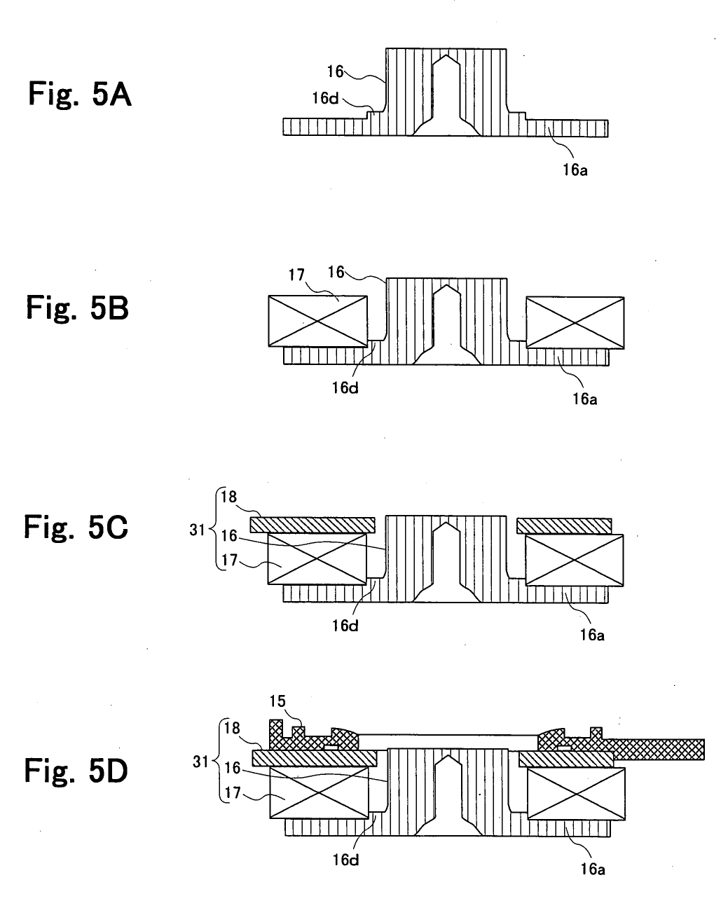

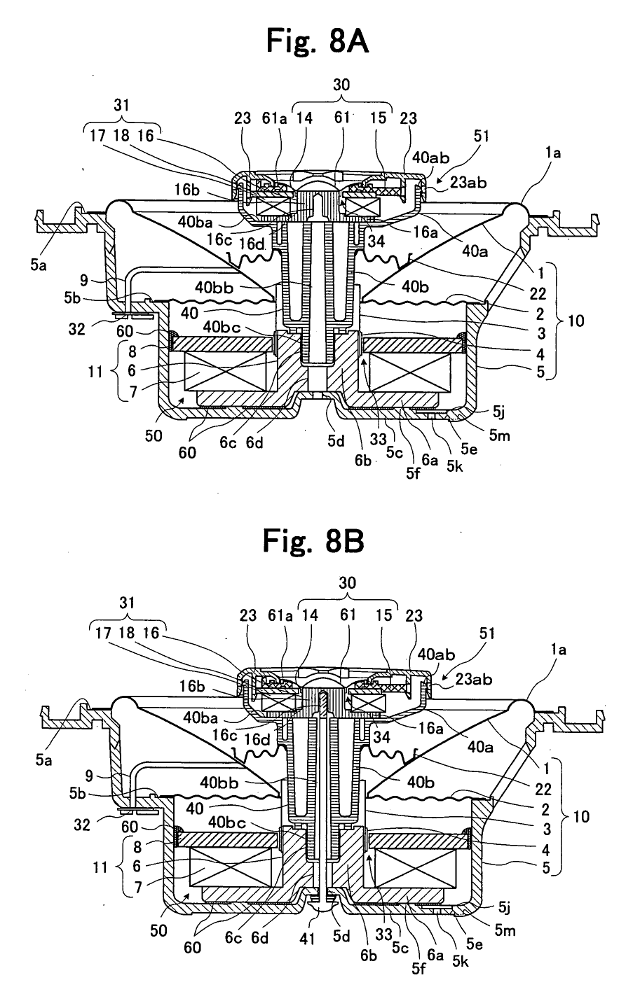

Next, the description will be given of a method of manufacturing the speaker device 100 according to an embodiment of the present invention, with reference to FIG. 3 to FIG. 8. The present invention is characterized in that the speaker unit 51 for high-frequency band reproduction is fixed to the supporting member 40. Therefore, the explanation of the method of manufacturing the speaker unit 50 for low-frequency band reproduction is omitted. FIG. 3 shows a flow chart of the manufacturing method of the speaker device 100. FIG. 4 shows a flow chart of the manufacturing method of the speaker unit 51 for high-frequency band reproduction. FIGS. 5A to 5D to FIGS. 7A and 7B show sectional views of the respective manufacturing processes of the speaker unit 51 for high-frequency band reproduction corresponding to the flow chart shown in FIG. 4. FIGS. 8A and 8B show sectional views of each manufacturing process of the speaker device 100 corresponding to steps S3 and S4 of the flow chart shown in FIG. 3.

First, the speaker unit 51 for high-frequency band reproduction is manufactured (step S1). Specifically, the speaker unit 51 for high-frequency band reproduction is manufactured in accordance with processes P1 to P3 shown in FIG. 4. First, in process P1, the magnetic circuit system 31 of the speaker unit 51 for high-frequency band reproduction is manufactured, and the upper frame is mounted onto the manufactured magnetic circuit system 31.

Namely, in process P1, an annular magnet 17 is mounted to the pole piece 16 shown in FIG. 5A via an adhesive agent (not shown). At this time, with the inner peripheral wall of the lower end portion of the annular magnet 17 contacting with the outer peripheral wall of the step portion 16d of the pole piece 16, the annular magnet 17 is fixed onto the yoke 16a via the adhesive agent. Thereby, the annular magnet 17 is accurately positioned at the appropriate position on the yoke 16a. Like this, FIG. 5B shows a state that the annular magnet 17 is mounted to the pole piece 16. Next, as shown in FIG. 5C, the annular plate 18 is mounted onto the upper surface of the annular magnet 17 via the adhesive agent (not shown). Thereby, the magnetic circuit system 31 is manufactured. Next, as shown in FIG. 5D, the upper frame 15 is mounted onto the upper surface of the annular plate 18 of the manufactured magnetic circuit system 31 via the adhesive agent (not shown).

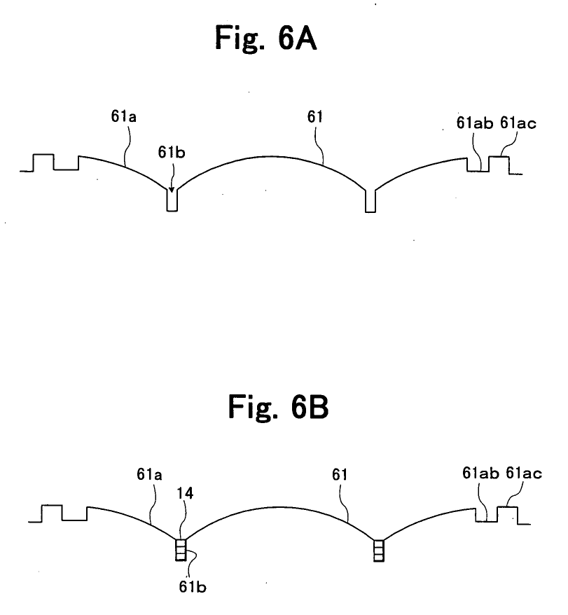

Next, in process P2, the voice coil 14 is attached to the diaphragm 61. Specifically, the voice coil 14 is wound around the inside of the groove 61b of the diaphragm 61 shown in FIG. 6A. FIG. 6B shows the state that the voice coil 14 is wound around the inside of the groove 61b of the diaphragm 61.

Next, in process P3, the diaphragm 61 around which the voice coil 14 is wound is mounted to the upper frame 15, and the cover 23 is further mounted to the magnetic circuit system 31.

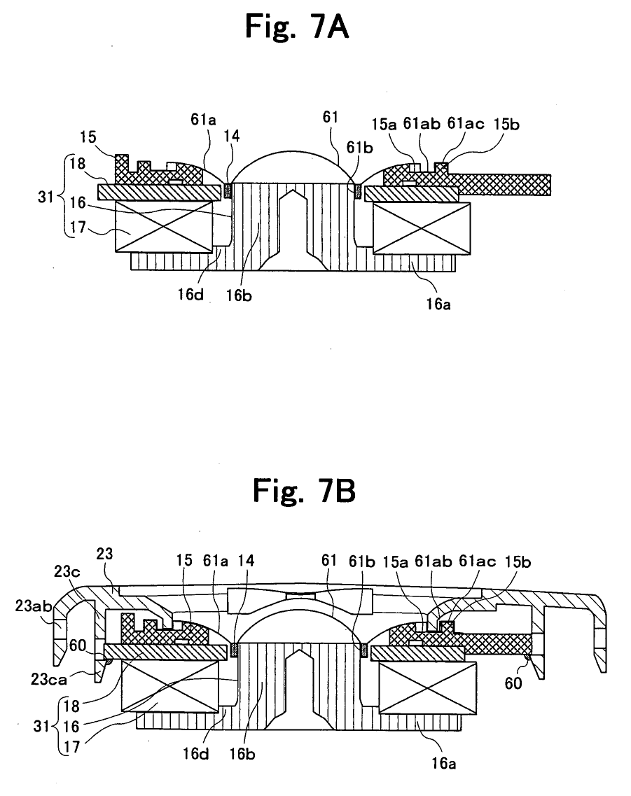

First, in process P3, the diaphragm 61 is mounted onto the upper frame 15 via the adhesive agent (not shown) so that the outer peripheral edge portion of the edge portion 61a of the diaphragm 61 and the upper surface of the upper frame 15 are overlapped. Specifically, as shown in FIG. 7A, the projecting portion 61ac of the diaphragm 61 is inserted to the engaging projecting portion 15b of the upper frame 15, and the lower surface of the recess portion 61ab of the diaphragm 61 is made to contact with the upper surface of the engaging recess portion 15a of the upper frame 15. Thereby, the groove 61b of the diaphragm 61 is positioned on the upper end portion of the center pole 16b. In addition, thereby, the engaging projecting portion 15b of the upper frame 15 prevents the diaphragm 61 from moving in the lateral direction, and the diaphragm 61 is stably fixed onto the upper frame 15.

Subsequently, in process P3, the cover 23 is mounted onto the magnetic circuit system 31. Concretely, the cover 23 is pushed into the magnetic circuit system 31. The recess portion 61ab of the diaphragm 61 is pushed and pressed by the lower surface of the projecting part 23b, and the claw portion 23ca of the engaging projecting part 23c engages with at least one portion of the lower surface of the outer peripheral edge portion of the plate 18. Next, the adhesive agent 60 is applied, in the entire circumference, between the claw portion 23ca and the one portion of the lower surface of the outer peripheral edge portion of the plate 18. In such the way, the cover 23 is mounted to the magnetic circuit system 31. As shown in FIG. 7B, in the above-mentioned processes P1 to P3, the speaker unit 51 for high-frequency band reproduction is manufactured.

Next, returning to FIG. 3, the speaker unit 51 for high-frequency band reproduction is mounted to the supporting member 40 (step S2). Specifically, first, the adhesive agent 60 is applied to the position of the upper end surface 40ba corresponding to the lower surface of the pole piece 16 which is the component of the magnetic circuit system 31. Next, each engaging claw 40ab of the frame portion 40a is inserted to each opening 23ab, and the lower surface of the pole piece 16 ensuring the flatness is fixed to the upper end surface 40ba ensuring the flatness. FIG. 8A shows such the state.

Thereby, since the magnetic circuit unit is sandwiched by the projecting part 23b of the cover 23 and the upper end surface 40ba, i.e., since the magnetic circuit unit is pushed and pressed on the side of the supporting member 40 by the projecting part 23b, the speaker unit 51 for high-frequency band reproduction is never leaned by its weight until the adhesive agent 60 is solidified. The supporting member 40 is never leaned, either. Therefore, the speaker unit 51 for high-frequency band reproduction can be stably fixed to the upper end surface 40ba of the supporting member 40.

Next, when the adhesive agent applied between the magnetic circuit unit and the upper end surface 40ba of the supporting member 40 is solidified to some degree, the speaker unit 51 for high-frequency band reproduction and the speaker unit 50 for low-frequency band reproduction are fixed by the fastening member 41 via the supporting member 40 (step S3). Specifically, the fastening member 41 is made to pass through the openings 5d, 6d and 6c and the through hole 40bb from the rear side opposite to the sound output side, and a point portion of the fastening member 41 is screwed into the fastening hole 16c of the pole piece 16. Thereby, as shown in FIG. 8B, the speaker unit 50 for low-frequency band reproduction and the speaker unit 51 for high-frequency band reproduction are coaxially fixed via the supporting member 40.

Next, other various members, i.e., the name plate 42 and the resin grille 21 are mounted (step S4). Specifically, the name plate 42 is attached to the recess portion 5e of the resin frame 5. The resin grille 21 is pushed into and mounted to the resin frame 5. In such the method, the speaker device 100 shown in FIGS. 1A and 1B is manufactured.

1. A speaker unit comprising:
a magnetic circuit unit;
a supporting member which has a frame portion supporting the magnetic circuit unit; and
a cover which is mounted to the frame portion and covers the magnetic circuit unit,
wherein the magnetic circuit unit is fixed to a supporting surface of the frame portion by an adhesive agent, and is sandwiched by the cover and the supporting surface.

2. The speaker unit according to claim 1,
wherein the frame portion has an engaging claw formed at a peripheral end portion,
wherein the cover has an opening formed in a vicinity of the peripheral end portion of the cover opposite to an outer circumferential wall of the peripheral end portion of the frame portion; and
wherein the cover is mounted to the frame portion by engaging the engaging claw with the opening.

3. The speaker unit according to claim 1, further comprising:
an upper frame which is fixed onto the magnetic circuit unit; and
a diaphragm which is fixed onto the upper frame and has an edge portion,
wherein a recess portion is formed at an outer peripheral edge portion of the edge portion,
wherein a projecting part projecting to a side of the recess portion is formed at a position on the cover, opposite to the recess portion, and
wherein the projecting part pushes and presses the magnetic circuit unit via the recess portion and the upper frame.

4. The speaker unit according to claim 3,
wherein a projecting portion is formed at the outer peripheral edge portion of the edge portion, and an engaging projecting portion is formed at a position corresponding to the projecting portion on an upper surface of the upper frame, and
wherein the projecting portion and the engaging projecting portion are in contact with each other.

5. The speaker unit according to claim 1,
wherein the magnetic circuit unit includes a plate arranged opposite to a lower surface of the upper frame,
wherein the cover has an engaging projecting part projecting to a side of an outer peripheral edge portion of the plate,
wherein a claw portion is formed at a peripheral end portion of the engaging projecting part,
wherein the claw portion engages with at least one portion of a lower surface of the outer peripheral edge portion of the plate, and
wherein the plate is sandwiched by the claw portion and the projecting part.

6. A coaxial speaker device, comprising:
a speaker unit for high-frequency band reproduction, including a magnetic circuit unit, a supporting member having a frame portion supporting the magnetic circuit unit, and a cover mounted to the frame portion and covering the magnetic circuit unit, wherein the magnetic circuit unit is fixed to a supporting surface of the frame portion by an adhesive agent and is sandwiched by the cover and the supporting surface; and
a speaker unit for low-frequency band reproduction,
wherein the speaker unit for low-frequency band reproduction and the speaker unit for high-frequency band reproduction are coaxially disposed via the supporting member, and
wherein an end portion opposite to the frame portion of the supporting member is mounted to the speaker unit for low-frequency band reproduction.

7. The coaxial speaker device according to claim 6,
wherein the supporting member is formed by integrating a connecting portion connecting the speaker unit for low-frequency band reproduction and the speaker unit for high-frequency band reproduction and the frame portion functioning as a lower frame of the speaker unit for high-frequency band reproduction.

8. A method of manufacturing a coaxial speaker device, comprising:
a process which inserts a lower end portion of a supporting member to an opening formed at a center portion of a speaker unit for low-frequency band reproduction, thereby to fix the supporting member to the speaker unit for low-frequency band reproduction;
a process which fixes a magnetic circuit unit of a speaker unit for high-frequency band reproduction to an upper end surface of a frame portion, which is one portion of the supporting member, by an adhesive agent;
a process which mounts a cover, having a projecting portion pushing and pressing the magnetic circuit unit, to the frame portion to cover the magnetic circuit unit; and
a process which inserts a fastening member from a direction opposite to a sound output side to the opening of the speaker unit for low-frequency band reproduction and a through hole passing through a central axis of the supporting member, thereby to fix the speaker unit for low-frequency band reproduction, the supporting member and the speaker unit for high-frequency band reproduction.
